(19) United States
(12) Patent Application Publication
(10) Pub. No.: US 2005/0289516 A1
(43) Pub. Date: Dec. 29, 2005

(54) Method and apparatus for conducting test and computer product

(75) Inventor: Hirotaka Fukushima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/972,054

(22) Filed: Oct. 25, 2004

(30) Foreign Application Priority Data
Jun. 29, 2004 (JP) 2004-191561

(51) Int. Cl. G06F 9/44

(52) U.S. Cl. 717/125

(57) ABSTRACT

An apparatus for conducting a test for various functions in a device using test programs that are created based on test items includes a storage unit that stores program information that includes information on the test programs and commands necessary for executing the test programs, and command information that indicates whether the device supports the commands; and a determining unit that determines, based on the program information and the command information, whether the test can be conducted on the device using the test programs. The test is conducted on the device using the test programs when the determining unit determines that the test can be conducted.

### BACKGROUND OF THE INVENTION

1) Field of the Invention

The present invention relates to a technology for conducting a test for various functions in a device.

2) Description of the Related Art

Conventionally, a test conducting apparatus has been devised to test various functions in a device. The test conducting apparatus checks the functions by executing commands on the device using a test program.

However, if there is even a single command that is not supported by a target device to be tested in the commands, a process is halted during a test. In that case, cost and time, which is spent for calculation until the process is halted, are wasted, and efficiency of the test is low.

To solve such problems of wasting the cost and the time, a system for automatically selecting test items is disclosed in Japanese Patent Application Laid-Open No. H1-295339. In the system, support status of each of commands in the target device is checked in advance, and only test programs that execute commands that are supported by the target device are selected to conduct a test.

However, in the conventional technology, it is difficult to check all commands supported by the tested device, and the test programs cannot be efficiently executed.

Because a number of test programs used in the test is voluminous, it is difficult to check the support status for commands of all the test programs. If the support status is not completely checked in a device, an inefficient test is conducted on the device.

### SUMMARY OF THE INVENTION

It is an object of the present invention to solve at least the above problems in the conventional technology.

An apparatus for conducting a test for various functions in a device using test programs that are created based on test items according to one aspect of the present invention includes a storage unit that stores program information that includes information on the test programs and commands necessary for executing the test programs, and command information that indicates whether the device supports the commands; and a determining unit that determines, based on the program information and the command information, whether the test can be conducted on the device using the test programs, wherein the test is conducted on the device using the test programs when the determining unit determines that the test can be conducted.

A method for conducting a test for various functions in a device using test programs that are created based on test items according to another aspect of the present invention includes retrieving program information that includes information on commands necessary for executing the test programs, and command information that indicates whether the device supports the commands, when the device is tested using the test programs; and determining, based on the test program information and the command information retrieved, whether the test can be conducted on the device. When the determining determines that the test can be conducted, the test is conducted on the device using the test programs.

A computer program product according to still another aspect of the present invention realizes a method according to the above aspect.

A computer-readable recording medium according to still another aspect of the present invention stores a computer program product for realizing a method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a test conducting apparatus according to an embodiment;

FIG. 2 is a command support table;

FIG. 3 is an explanatory diagram for explaining update of the command support table;

FIG. 4 is a test item table; and

FIG. 5 is a flowchart of a test conducting process.

### DETAILED DESCRIPTION

Exemplary embodiments of an apparatus and a method for conducting a test and a computer product will be explained in detail with reference to the accompanying drawings.

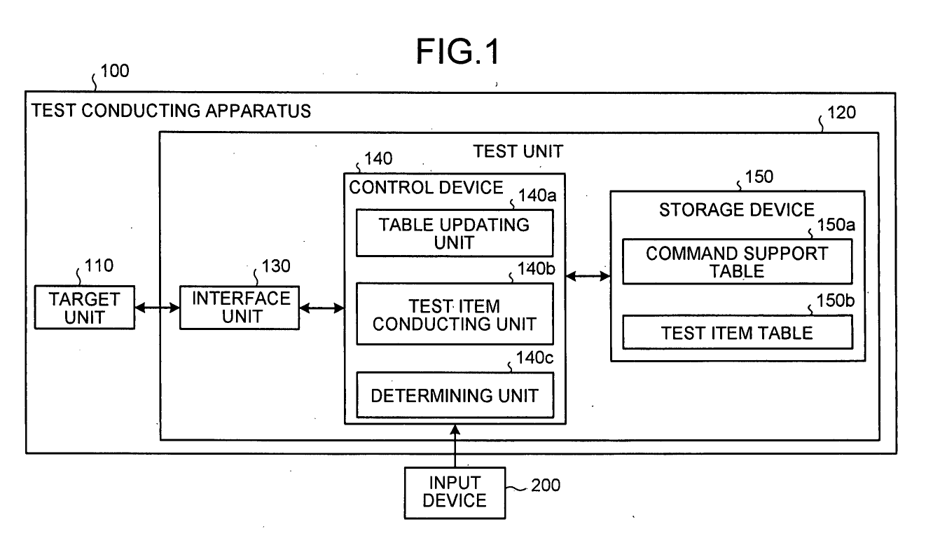

FIG. 1 is a block diagram of the test conducting apparatus according to an embodiment. As shown in FIG. 1, a test conducting apparatus 100 is connected to an input device 200 such as a keyboard and a mouse. The test conducting apparatus 100 includes a target unit 110 that undergoes a test and a test unit 120. The target unit 110 includes programs that are tested.

The test unit 120 tests the programs in the target unit 110. The test unit includes an interface unit 130, a control device 140, and a storage device 150. The interface unit 130 is a processor that transmits/receives data to/from the target unit 110.

The control device 140 includes a table updating unit 140a, a test-item conducting unit 140b, and a determining unit 140c. The table updating unit 140a updates a command support table 150a that is stored in the storage device 150.

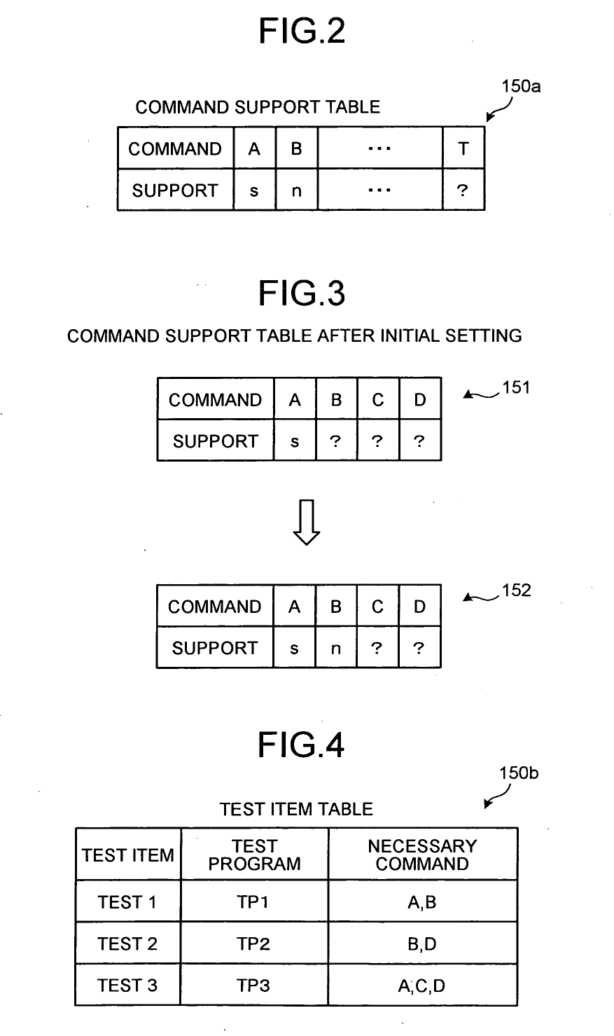

FIG. 2 is a command support table. As shown in FIG. 2, the command support table 150a includes information on a “command” and a “support”. The “command” represents instructions to make the target unit 110 execute a predetermined process, and the “support” represents support status of the target unit 110 for a predetermined command.

A character “s” shown in a support column in FIG. 2 indicates that the target unit 110 supports a command, a character “n” represents that the target unit 110 does not support a command, and a mark “?” indicates that whether the target unit 110 supports a command is unknown.

For example, in the command support table 150a shown in FIG. 2, a support status for a command “A” is “s”, a support status for a command “B” is “n”, and a support status for a command “T” is “?”.

The table updating unit 140a accepts initial setting information relating to the command support table 150a from the input device 200. The table updating unit 140a initializes the command support table 150a based on the initial setting information. The initial setting information includes information on commands and support status for the commands.

The table updating unit 140a receives, from the test-item conducting unit 140b, information on commands that are used in a test conducted and support status for the commands. The table updating unit 140a updates the command support table 150a based on the information received.

For example, the command support table initialized is set as shown in a command support table 151 in FIG. 3. When the table updating unit 140a receives, from the test-item conducting unit 140b, information that a command “B” is not supported after, the table updating unit 140a updates a support status corresponding to the command “B” to “n” as shown in a command support table 152.

The test-item conducting unit 140b tests the target unit 110 based on a test item table 150b and the determining unit 140c.

FIG. 4 is a test item table. As shown in FIG. 4, the test item table 150b includes information on a “test item”, a “test program”, and a “necessary command”. The “test item” is for classifying the test programs, the “test program” is a program that is executed by the test-item conducting unit 140b, and the “necessary command” is a command that is necessary for conducting a test by a corresponding test program.

For example, in the test item table 150b shown in FIG. 4, for a test item “test 1”, the test program is “TP1” and the necessary commands are “A and B”, and for a test item “test 2”, the test program is “TP2” and the necessary commands are “B and D”, and for a test item “test 3”, the test program is “TP3”, and the necessary commands are “A, C, and D”. The test-item conducting unit 140b conducts the test 1, the test 2, and the test 3 in this order.

The test-item conducting unit 140b selects a test item from the test item table 150b, and inquires the determining unit 140c whether a test of the test item selected can be conducted on the target unit 110.

When the test-item conducting unit 140b receives, from the determining unit 140c, information that the test can be conducted, the test-item conducting unit 140b executes a test program that corresponds the test item to test the target unit 110. After the test, the test-item conducting unit 140b notifies the table updating unit 140a of a support status of commands for the test program.

When the test-item conducting unit 140b receives information that the test cannot be conducted from the determining unit 140c, it does not conduct the test related with the selected test item, but selects a next test item and inquires the determining unit 140c whether the test can be conducted.

The determining unit 140c determines whether the test can be conducted based on the information received from the test-item conducting unit 140b, the command support table 150a, and the test item table 150b. The determining unit 140c notifies a result of the determination to the test-item conducting unit 140b.

The determining unit 140c receives information on the test item, for example, “test 1”, from the test-item conducting unit 140b. The determining unit 140c retrieves the commands “A and B” corresponding to the test item “test 1” based on the information received and the test item table 150b.

The determining unit 140c determines whether the target unit 110 supports the commands based on the command support table 150a. When the target unit 110 supports all the commands retrieved or when the support status is unknown, the determining unit 140c determines that the test can be conducted.

On the other hand, when the commands retrieved include even a single command that is not supported by the target unit 110, the determining unit 140c determines that the test cannot be conducted.

For example, when the commands retrieved by the determining unit 140c are “A and B” and the command support table 150a is set as shown in FIG. 2, the support status for the command “A” is “s (supported)”, but the support status for the command “B” is “n (no supported)”. Therefore, the determining unit 140c determines that the test cannot be conducted.

Since the determining unit 140c determines whether the test can be conducted and notifies a result of the determination to the test-item conducting unit 140b in advance of conducting the test, the test-item conducting unit 140b can test the target unit 110 efficiently.

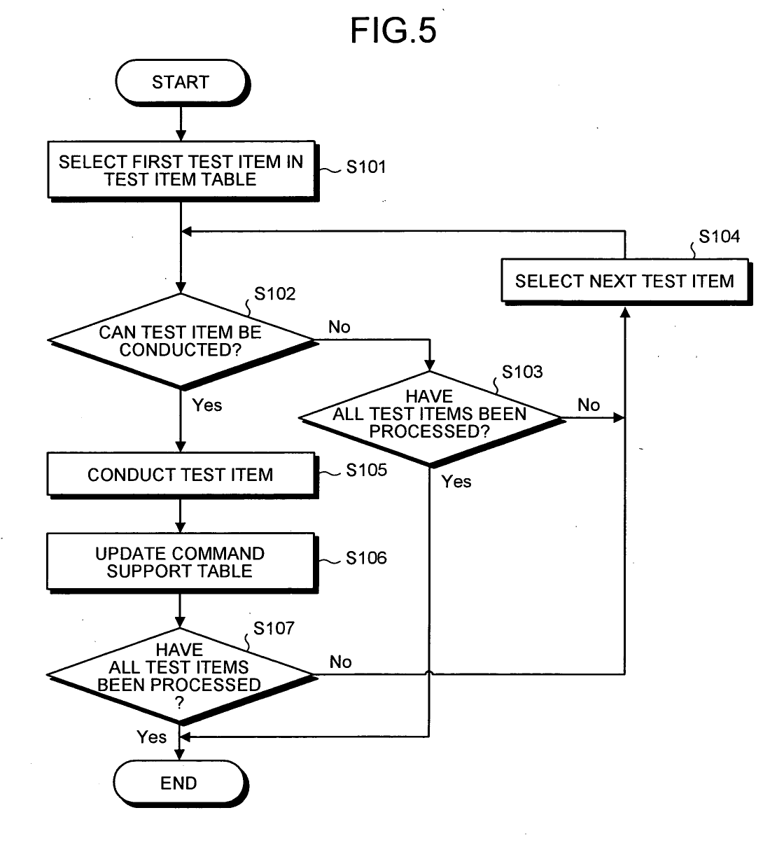

FIG. 5 is a flowchart of the test conducting process. The test-item conducting unit 140b selects a test item that is listed first in the test item table 150b (step S101). The determining unit 140c determines whether the test item selected can be conducted (step S102).

When the determining unit 140c determines that the test item cannot be conducted (“NO” at step S102), the test-item conducting unit 140b determines whether all the test items have been processed (step S103). When not all the test items have been processed (“NO” at step S103), the test-item conducting unit 140b selects a next test item (step S104). When all the test items have been processed (“YES” at step S103), the test conducting process is finished.

On the other hand, when the determining unit 140c determines that the test item can be conducted (“YES” at step S102), the test-item conducting unit 140b conducts the test item (step S105). The test-item conducting unit 140b makes the table updating unit 140a update the command support table 150a (step S106), and determines whether all the test items have been processed (step S107).

When not all the test items have been processed (“NO” at step S107), the process proceeds to step S104, and when all the test items have been processed (“YES” at step S107), the test conducting process is finished.

The determining unit 140c determines whether the target unit 110 supports commands based on the command support table 150a, and when all the commands are supported, the determining unit 140c notifies that the test can be conducted to the test-item conducting unit 140b. Then, the test-item conducting unit 140b conducts a test on the target unit 110. Therefore, in the apparatus 100 according to the present embodiment, it is possible to prevent from conducting a test in vain, and thus, a test can be efficiently conducted.

Moreover, in the test conducting apparatus 100, since the determining unit 140c conducts a test excluding test items that cannot be conducted, cost required for calculation for the test can be reduced.

While in the present embodiment, a test is conducted on a target unit in a test conducting apparatus, it is not limited to this case, and the present invention can be applied similarly to an external device to be tested, by determining whether commands are supported by the external device, and by selecting test programs executable to test the external device.

According to the present invention, it is possible to efficiently conduct a test eliminating time that is spent wastefully for calculation.

According to the present invention, it is not necessary to check command conditions of a target device in advance of conducting a test, and thus, a load on a user can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for conducting a test for various functions in a device using test programs that are created based on test items, comprising:
a storage unit that stores program information that includes information on the test programs and commands necessary for executing the test programs, and command information that indicates whether the device supports the commands; and
a determining unit that determines, based on the program information and the command information, whether the test can be conducted on the device using the test programs, wherein
the test is conducted on the device using the test programs when the determining unit determines that the test can be conducted.

2. The apparatus according to claim 1, wherein
the determining unit determines that the test can be conducted when the device supports all the commands.

3. The apparatus according to claim 1, further comprising an updating unit that updates the command information, wherein
when it is unknown whether the device supports a command, the updating unit conducts a test on the device using a test program that includes the command, and the updating unit updates the command information based on a result of the test.

4. A method for conducting a test for various functions in a device using test programs that are created based on test items, comprising:
retrieving program information that includes information on commands necessary for executing the test programs, and command information that indicates whether the device supports the commands, when the device is tested using the test programs; and
determining, based on the test program information and the command information retrieved, whether the test can be conducted on the device, wherein
when the determining determines that the test can be conducted, the test is conducted on the device using the test programs.

5. The method according to claim 4, wherein the determining determines that the test can be conducted when the device supports all the commands.

6. The method according to claim 4, further comprising updating the command information, wherein
when it is unknown whether the device supports a command, the updating includes conducting a test on the device using a test program that includes the command, and the updating updates the command information based on a result of the test.

7. A computer program product for realizing a method for conducting a test for various functions in a device on a computer using test programs that are created based on test items, the computer program makes the computer execute:
retrieving program information that includes information on commands necessary for executing the test programs, and command information that indicates whether the device supports the commands, when the device is tested using the test programs; and
determining, based on the test program information and the command information retrieved, whether the test can be conducted on the device, wherein
when the determining determines that the test can be conducted, the test is conducted on the device using the test programs.

8. The computer program product according to claim 7, wherein the determining determines that the test can be conducted when the device supports all the commands.

9. The computer program product according to claim 7, further comprising updating the command information, wherein
when it is unknown whether the device supports a command, the updating includes conducting a test on the device using a test program that includes the command, and the updating updates the command information based on a result of the test.

10. A computer-readable recording medium that stores a computer program for realizing a method for conducting a test for various functions in a device on a computer using test programs that are created based on test items, the computer program makes the computer execute:
retrieving program information that includes information on commands necessary for executing the test programs, and command information that indicates whether the device supports the commands, when the device is tested using the test programs; and
determining, based on the test program information and the command information retrieved, whether the test can be conducted on the device, wherein
when the determining determines that the test can be conducted, the test is conducted on the device using the test programs.

11. The computer-readable recording medium according to claim 10, wherein the determining determines that the test can be conducted when the device supports all the commands.

12. The computer-readable recording medium according to claim 10, wherein the computer program further makes a computer execute updating the command information, and when it is unknown whether the device supports a command, the updating includes conducting a test on the device using a test program that includes the command, and the updating updates the command information based on a result of the test.
